(19) United States
(12) Patent Application Publication
(10) Pub. No.: US 2023/0203663 A1
(43) Pub. Date: Jun. 29, 2023

(54) CORROSION RESISTANT MULTILAYER COATINGS

(71) Applicants: SHILPA MEDICARE LIMITED, RAICHUR (IN); INNOVATIVE NANO & MICRO TECHNOLOGIES PVT LTD (INM TECHNOLOGIES), Bangalore (IN)

(72) Inventors: NAVEEN SHIVAPPA CHICKMAGLUR, Bangalore (IN); BAIJAYANTI GHOSH, Bangalore (IN); RATNA PHANI AYALASOMAYAJULA, Bangalore (IN)

(73) Assignees: SHILPA MEDICARE LTD, RAICHUR (IN); INNOVATIVE NANO & MICRO TECHNOLOGIES PVT LTD (INM TECHNOLOGIES), Bangalore (IN)

(21) Appl. No.: 16/499,243

(22) PCT Filed: Apr. 4, 2018
(86) PCT No.: PCT/IB2018/052311

§ 371 Date: Sep. 28, 2019

(30) Foreign Application Priority Data
Apr. 14, 2017 (IN) 201741013378

(51) Int. Cl. C23C 28/04

(52) U.S. Cl. CPC C23C 28/048; C23C 28/042

(57) ABSTRACT

The present invention relates to a multilayer coating on a metal substrate comprising (a) A first distinct layer of a first sol-gel composition disposed over the substrate, wherein the first distinct layer comprises an inorganic oxide, (b) a second distinct layer of a second sol-gel composition disposed over the first distinct layer, wherein the second distinct layer comprises silica and ceria, and (c) a third distinct layer of a third sol-gel composition disposed over the third distinct layer, wherein the third distinct layer comprises at least one alkoxysilane and the process for the preparation of thereof.

### FIELD OF INVENTION

The present invention relates to corrosion-resistant coating compositions and a process for applying the same. More particularly, the invention relates to thin, multiple layer coatings composed of layers and Preferably, the multiple layers of coating are applied by means known per se to the person skilled in the art, especially by dip coating, by spray-coating or by application by means of a paint brush, a pad or a brush or roll coater for localized uses as spreading of coating of the surface of the solid metal substrate. The coatings can be applied to the surfaces of various articles in order to provide beneficial surface properties to the articles, especially for the substrates prone for corrosion.

### BACKGROUND OF THE INVENTION

The use of coatings to provide corrosion protection to an underlying article or substrate is common. Protective coatings can include organic coatings such as paints and epoxies; non-metallic coatings such as cements, enamels or oxides; and metallic coatings such as chrome and gold plating. Research on improving protective coatings has been extensive for many different materials and applications. The objective of protective coatings is to provide corrosion resistance of substrate to the various environments the substrate may encounter. Many coatings are limited to particular environments because of their inability to with stand certain temperature and/or corrosive conditions. The use of organic binders in many coatings limits the use of these coatings at elevated temperatures. A coating not requiring organic binders may withstand elevated temperatures.

Additionally, many articles requiring corrosion protection have specific weight limitations. Therefore, thinner and accordingly lighter coatings are desired. Thinner coatings are also desirable because they require less material, do not significantly change the substrate size, and offer the potential to reduce material costs. Protective coatings, regardless of their compositions and the manner in which they are applied, must be adherent to the substrate they are to protect. In order to protect the underlying substrate, the protective coatings must act as the protective barrier against the corrosive agent or as a sacrificial layer. Sacrificial protective layers have the disadvantage that the sacrificial layer only provides temporary protection and must be replaced once it has been expended.

In organic coatings have also been used for corrosion protection. However, inorganic coatings are typically made of materials that have low coefficients of the thermal expansion relative to the higher coefficient of thermal expansion metal substrates they are intended to protect. While inorganic coatings may perform adequately at a particular temperature, the inorganic coatings on the metal substrates are not able to withstand large temperature changes. When the metal substrate and the coating are subject to large temperature increases or decreases, the underlying metal substrate expands and contracts, respectively, to a greater degree than the inorganic coating. The coefficient of expansion mismatch causes the brittle inorganic coating to crack and break away from the surface of the metal, a phenomenon known as spalling. Thus, the metal is no longer protected by the coating and may become exposed to the corrosive agents.

Metals have been used as protective coatings. However, most metals are subject to corrosion, especially at elevated temperatures and in aqueous, salt and acidic environments. Additionally, metal coatings are expensive, heavy and can be removed by abrasion.

In order to overcome, the above disadvantages inventors of U.S. Pat. No. 6,214,473 have developed and improved corrosion resistant coating which is more durable and effective under broader range of conditions, particularly at elevated temperatures and in saline and acidic environments, which comprises a multilayer inorganic coating on a metal substrate. In the multiple layer coatings of US '473 patent, the coatings comprise alternating discrete layers of silica and chromia; silica and zinc phosphate, wherein the silica layer may be doped or undoped layer of silica; silica and zinc phosphate, wherein the silica layer may be a doped or undoped layer of ceria. With the usage of the multiple layer coatings as disclosed in US '473 patent, minor corrosion of brass substrate occurred after 17 days.

Pepe etal (2004, Journal of Non-Crystalline Solids, 348, 162-171) discloses the coating based on silica gel on the surface made of aluminium alloy by a sol/gel process. Such a treatment is carried out by dip-coating the substrate made of aluminium alloy in a hybrid solution of tetraethyl orthosilicate (TEOS) and methyltriethoxysilane (MTES) containing cerium nitrate. Such a process does not permit the obtainment of an anticorrosion coating that has both improved properties and mechanical resistance-especially resistance to tearing- and also improved healing properties and an improved barrier effect.

US Publication No. 20140255611A1 discloses anticorrosion treatment with a liquid solution comprising at least one alkoxysilane and at least one cerium (Ce) cation in a liquid hydroalcholic composition. Such coatings are efficient only for the 100 hours.

In order to overcome the above disadvantages, there still exists a needs to develop an anticorrosive coating which is more effective and durable.

### OBJECTS OF THE INVENTION

The object of the present invention is to provide a novel corrosion resistant multilayer inorganic coatings that are particularly useful for articles which are used at elevated temperatures, that are subjected to large temperature changes and corrosive combustion gases but still be beneficial for substrates which are never exposed to elevated temperatures.

### SUMMARY OF THE INVENTION

The present invention relates to a multilayer coating on a metal substrate comprising (a) A first distinct layer of a first sol-gel composition disposed over the substrate, wherein the first distinct layer comprises an inorganic oxide (b) A second distinct layer of a second sol-gel composition disposed over the first distinct layer, wherein the second distinct layer comprises silica and ceria, and (c) A third distinct layer of a third sol-gel composition disposed over the third distinct layer, wherein the third distinct layer comprises at least one alkoxysilane.

The present invention further relates to a multilayer coating on a steel substrate comprising (a) A first distinct layer of a first sol-gel composition disposed over the substrate, wherein the first distinct layer comprises ferric oxide, (b) A second distinct layer of a second sol-gel composition disposed over the first distinct layer, wherein the second distinct layer comprises silica and ceria, and (c) A third distinct layer of a third sol-gel composition disposed over the third distinct layer, wherein the third distinct layer comprises at least one alkoxysilane.

### BRIEF DESCRIPTION OF DRAWINGS

FIG. 1: Schematic diagram of the three distinct layers coated on the metal substrate. The first distinct layer comprises inorganic oxide of base metal substrate, second distinct layer comprises silica (silicon dioxide) and ceria (cerium oxide) prepared from precursors of TEOS and Cerium nitrate hexahydrate respectively, and third distinct layer comprises TEOS, MTMS and optionally a surfactant.

FIG. 2: Tafel Plot of applied potential vs. the logarithm of the measured current of example 1.

FIG. 3: Corrosion rate vs. Time of example 1.

FIG. 4: Inhibition efficiency (%) vs Time of example 1.

FIG. 5: Circuit diagram used to fit EIS data. In the circuit diagram 1 denotes solution resistance of electrolyte, 2 denotes pseudo capacitance of the multi-layer coated substrate sample of example 1, 3 denotes pore resistance of the multi-layer coated substrate sample of example 1, 4 denotes the pseudo capacitance of intermediate oxide layer formed during corrosion reaction and 5 denotes pore resistance of intermediate oxide layer formed during corrosion reaction.

FIG. 6: Phase vs. log frequency to design the circuit diagram of FIG. 5

FIG. 7: log z (impedance) vs. log frequency of multi-layered coated sample of example 1 in comparison to bare steel substrate.

FIG. 8 (a): Plot of log Rsg vs. time of multi-layered coated sample of example 1.

FIG. 8(b): Plot of log Rox vs. time of multi-layered coated sample of example 1.

FIG. 9(a): Scanning electron microscopy image of scratched multi-layered coated sample of example 1 at 0 hours, where D1 width of scratch and D2 depicts width of total area damaged.

FIG. 9(b): Scanning electron microscopy image of scratched multi-layered coated sample of example 1 at 48 hours that was healed, where D1 width of scratch and D2 depicts width of total area damaged.

FIG. 10(a): Elemental Analysis of scratched multi-layered coated sample of example 1 at 0 hours.

FIG. 10(b): Elemental Analysis of scratched multi-layered coated sample of example 1 at 48 hours that was healed.

FIG. 11: Plot of log z vs. log frequency at 0, 3.5 and 48 hours of scratched multi-layer coated sample of example 1.

FIG. 12: Tafel Plots of potential vs. the logarithm of the measured current for base steel substrate, reference example A, B and multi-layered coated sample of example 1.

FIG. 13: Corrosion rate vs. Time plot for reference example A, B, C and multi-layered coated sample of example 1.

FIG. 14: Inhibition efficiency vs Time plot for reference example A, B, C and multi-layered coated sample of example 1.

FIG. 15: Corrosion rate vs. Time of Example 5.

FIG. 16: Inhibition efficiency (%) vs Time of example 5.

FIG. 17: Inhibition efficiency vs Time plot for reference example D and multi-layered coated sample of example 5.

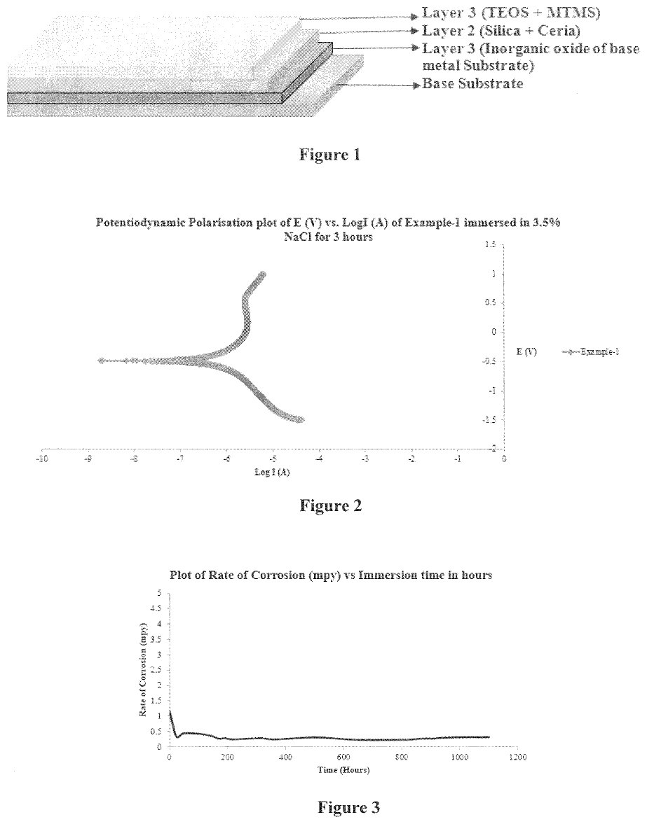

### BRIEF DESCRIPTION OF THE INVENTION

Metals, in particular non-noble metals, are susceptible to corrosion. Corrosion-resistant coatings have been applied to the surface of metals to protect the metal from the corrosive agent(s). The coatings must be able to withstand the corrosive agents and any environmental conditions which the coating and underlying metal are likely encounter. Two types of corrosion-resistant coatings currently used include organic coatings, such as plastic coatings and paints, and inorganic coatings. The organic coatings, while typically easy to apply, do not always provide sufficient protection in all environmental conditions. Organic coatings and coatings containing organic components degrade or melt at high temperatures and therefore are not able to withstand elevated temperatures.

Although, inorganic coatings are better able to withstand elevated temperatures they are more difficult to apply than organic coatings. Additionally, inorganic coatings, such as aluminium oxide, silicon dioxide, chromium oxide, etc., typically have low coefficients of thermal expansion relative to the metals, steel, aluminium, copper, brass, etc., upon which they are coated to protect. When the metal substrates and the overlying inorganic coatings are subject to large temperature changes, the metal substrate expands to a greater degree than the overlying inorganic coating. The coefficient of expansion mismatch causes the brittle inorganic coatings to crack and break away from the surfaces of the metal substrate, a phenomenon referred to as spalling. Thus, the metal substrate is no longer protected by the inorganic coating and may become exposed to the corrosive agents.

The present invention teaches an improved coating system that is better able to withstand elevated temperatures and with improved corrosion resistance. The improved performance of the coatings is obtained by using thin layers which are better able to withstand the large temperature changes and by using multiple layers which provide improved corrosion resistance. Such coating systems are useful for protecting most metal substrates, including steel, aluminium, magnesium, iron, copper, nickel, and titanium alloys. Also, composites containing metals can be protected or a metal substrate of any material with a metal coating thereon can be similarly protected. As used herein the term “substrate” is intended to include articles. The coatings are particularly useful for articles which are used at elevated temperatures, that are subject to large temperature changes and corrosive combustion gases but can still be beneficial for substrates which are never exposed to elevated temperatures.

The coating systems in accordance with the present invention comprise at least three thin, distinct layers of three differing compositions. The coating systems may include any number of additional layers, with fewer layers being more economical and easier to apply. Coating systems comprising thinner layers are preferred because thin layers reduce cost and weight and are preferred in applications in which weight and cost are critical factors such as components of automobiles and airplanes. Ideally, the layers making up the coating should be as thin as possible while still providing sufficient corrosion protection. A coating system in which each of the individual layers is less than 400 nanometers (nm) in thickness is preferred.

One aspect of the present invention involves the composition of the layers. At least one of the layers should comprise a corrosion-resistant composition. Preferably, each layer is useful in corrosion resistance or passivation. The multilayer coatings of the invention, as demonstrated in the Examples below, have good adhesion to the substrate and excellent corrosion protection. The coatings may be composed of readily available, inexpensive materials. The multilayers may be applied to various metal substrates which are subject to corrosion, including but not limited to: steel, magnesium, aluminium, iron, titanium, tin, copper, nickel and alloys of the previously mentioned metals.

The present invention provides a multilayer coating on a metal substrate comprising (a) A first distinct layer of a first sol-gel composition disposed over the substrate, wherein the first distinct layer comprises an inorganic oxide (b) A second distinct layer of a second sol-gel composition disposed over the first distinct layer, wherein the second distinct layer comprises silica and ceria, and (c) A third distinct layer of a third sol-gel composition disposed over the third distinct layer, wherein the third distinct layer comprises at least one alkoxysilane.

In one embodiment, the preferred inorganic oxides of the first distinct layer are selected from the group consisting of iron oxides (ferric oxide or ferrous oxide), aluminium oxide, titanium oxide, copper oxides (copper oxide or cupric oxide) tin oxide, nickel oxide and magnesium oxide or combinations thereof. More preferably inorganic oxides used in the first distinct layer are inorganic oxides of metal base substrate, for example; for the steel substrate, the inorganic oxide used in the first distinct layer is ferric oxide; for the aluminium substrate, the inorganic oxide used in first distinct layer is aluminium oxide; for the tin substrate, the inorganic oxide used in first distinct layer is tin oxide. The precursors used for the inorganic oxides of ferric oxide and aluminium oxides of the preferred embodiments are Iron(II) chloride tetrahydrate (ferrous chloride tetrahydrate) and aluminium sec-butoxide respectively. In embodiments of the invention, the solvent used for dissolving the precursors Iron(II) chloride tetrahydrate and aluminium sec-butoxide is 2-methoxyethanol for preparation of ferric oxide and aluminium oxide respectively.

In another embodiment of the invention, the second distinct layer of silica (silicon dioxide) and ceria (cerium oxide) is prepared from precursors TEOS (tetraethoxysilane or tetraethyl orthosilicate) and cerium(III) nitrate hexahydrate. The term “silica” as used herein is meant to include all binary compounds of silicon and oxygen, SiₓO_{y}, of which the preferable compound is silicon dioxide, SiO₂. The term “ceria” as used herein is meant to include all binary compounds of cerium and oxygen, CeₓO_{y}, particularly cerium dioxide, CeO₂. Preferably, the precursors of TEOS and cerium(III) nitrate hexahydrate are dissolved in 2-methoxyethanol for the preparation of second distinct layer comprising silica and ceria. In embodiments of the invention preferably TEOS and cerium (III) nitrate hexahydrate are used in the ratio from about 5:1 to about 1:5, more preferably in the ratio of about 4:1. Most preferably the second distinct layer of silica and ceria are prepared from its precursors consisting of about 80% w/w of TEOS and of about 20% w/w cerium nitrate hexahydrate based on the total weight of the sol-gel composition of the second distinct layer.

In further embodiments of the invention, the third distinct layer comprises alkoxysilanes and optionally a surfactant. In embodiments of the invention alkoxysilanes are selected from the group consisting of methyltrimethoxysilane (MTMS), tetraethoxysilane (TEOS), methyltriethoxysilane (MTES) and dimethyldimethoxysilane, and mixtures thereof, preferred alkoxysilanes being TEOS and the MTMS. The third distinct layer preferably comprises of about 50% w/w to about 60% w/w TEOS and of about 20% w/w to about 45% w/w MTMS based on total weight of the third distinct layer, most preferably the third distinct layer comprised of about 60% w/w TEOS and 38% w/w of MTMS based on the total weight of composition of third distinct layer.

In embodiments of the invention, the third distinct layer may further comprise a surfactant. The surfactants are selected from sodium dodecyl sulfate (sodium lauryl sulfate), polysorbate (Tween), Lauryl dimethyl amine oxide, cetyltrimethylammmonium bromide (CTAB), Polyethoxylated alcohols, Polyoxyethylene sorbitan, Octoxynol (Triton X100), N, N-dimethyldodecylamine-N-oxide, Hexadecyltrimethylammonium bromide (HTAB), Polyoxyl 10 lauryl ether, Brij 721™, Bile salts (sodium deoxycholate, sodium cholate), Polyoxyl castor oil (Cremophor), Nonylphenol ethoxylate (Tergitol). Cyclodextrins. Lecithin, Methylbenzethonium chloride (Hyamine), and preferably used surfactant is sodium dodecyl sulfate. Sodium dodecyl sulfate used in the third distinct layer is of about 1% w/w to 5% w/w based on the total weight of third distinct sol-gel layer composition. Most preferably sodium dodecyl sulfate used in the third distinct layer is about 2% w/w based on the total weight of the third distinct sol-gel layer composition.

In embodiments of the invention, the present invention provides multilayer coating on a steel substrate comprising (a) A first distinct layer of a first sol-gel composition disposed over the substrate, wherein the first distinct layer comprises ferric oxide, (b) a second distinct layer of a second sol-gel composition disposed over the first distinct layer, wherein the second distinct layer comprises silica and ceria, and (c) a third distinct layer of a third sol-gel composition disposed over the third distinct layer, wherein the third distinct layer comprises at least one alkoxysilane.

In further embodiments of the invention, the present invention provides multilayer coating on an aluminium substrate comprising (a) A first distinct layer of a first sol-gel composition disposed over the substrate, wherein the first distinct layer comprises Aluminium oxide, (b) a second distinct layer of a second sol-gel composition disposed over the first distinct layer, wherein the second distinct layer comprises silica and ceria, and (c) a third distinct layer of a third sol-gel composition disposed over the third distinct layer, wherein the third distinct layer comprises at least one alkoxysilane.

In specific embodiments of the invention, the present invention provides a multilayer coating on a steel substrate comprising (a) a first distinct layer of a first sol-gel composition disposed over the substrate, wherein the first distinct layer comprises ferric oxide, (b) a second distinct layer of a second sol-gel composition disposed over the first distinct layer, wherein the second distinct layer comprises silica and ceria prepared from precursors of about 80% w/w tetraethoxysilane (TEOS) and of about 20% w/w cerium nitrate hexahydrate, and (c) a third distinct layer of a third sol-gel composition disposed over the third distinct layer, wherein the third distinct layer comprises alkoxysilanes consisting of about 60% w/w methyltrimethoxysilane (MTMS) and of about 38% w/w tetraethoxysilane (TEOS) and optionally of about 2% w/w of surfactant.

The formation of multiple layers of thin coatings is beneficial for corrosion resistance. The total thickness of the combined layers of the coating should be preferably less than about 40 microns wherein each of the individual layers is less than about 10 microns thick, more preferably total thicknesses of less than about 10 microns and individual layer thicknesses of less than about 2 microns, most preferably total thickness is of about 1200 nm and individual layer has the thickness of about 400 nm.

It is also desirable to have one or more of the layers on the third layer. The inclusion of a fracture tough or malleable layer provides additional wear and abrasion resistance to the substrate. An example of a wear resistant coating including a fracture tough or malleable layer can be provided by alternating layers of nickel. The nickel layers provide wear resistance and fracture toughness.

Preferably, the multiple layers of coating are applied by means known per se to the person skilled in the art, especially by dip coating, by spray-coating or by application by means of a paint brush, a pad or a brush or roll coater for localized uses as spreading of coating of the surface of the solid metal substrate.

In the embodiments of the present invention, the corrosion resistance is effective for at least 15 days, preferably for at least 20 days, 25 days, 30 days, 35 days and most preferably at least 40 days.

The following examples are provided to illustrate the present invention. It should be understood, however, that the invention is not limited to the specific conditions or details described in the examples below. The examples should not be construed as limiting the invention as the examples merely provide specific methodology useful in the understanding and practice of the invention and its various aspects. While certain preferred and alternative embodiments of the invention have been set forth for the purposes of disclosing the invention, modification to the disclosed embodiments can occur to those who are skilled in the art.

### Example 1: Multilayer Coatings on Steel Substrate

a) Making of sol-gel composition of first distinct layer (first distinct layer of ferric oxide): 20 g of iron(II) chloride tetrahydrate (ferrous chloride tetrahydrate) was mixed with 200 ml 2-methoxyethanol and stirred vigorously at 600 rpm for 4 hours to form the sol-gel composition of first distinct layer (first distinct layer of ferric oxide)
b) Making of sol-gel composition of second distinct layer (second distinct layer of silica-ceria): 18.8 g of TEOS (tetraethoxysilane or tetraethyl orthosilicate) was mixed with 200 ml of 2-methoxyethanol to form a yellow sol. Subsequently 4.3 g of cerium(III) nitrate hexahydrate was mixed with 200 ml of 2-methoxyethanol and vigorously stirred at 600 rpm for 4 hours to form an orange sol. Yellow sol and orange sol are mixed together in ratio of 1:1 volume such that the cerium concentration in the final sol was 0.05M to form a hybrid sol, which was further aged for 24 hours at room temperature to form the sol-gel composition of second distinct layer (second distinct layer of silica-ceria).
c) Making of sol-gel composition of third distinct layer (third distinct layer of hydrophobic alkoxysilane): 2.8 g of MTMS (methyltrimethoxysilane) was mixed with 100 ml of water and stirred for 30 minutes to obtain a MTMS transparent sol. Subsequently 0.1 g of sodium dodecyl sulfate was added to the MTMS transparent sol and stirred for 30 minutes. Subsequently 2 ml of 25% of ammonia and 1.8 g of TEOS (tetraethoxysilane or tetraethyl orthosilicate) to the above sol, which was further aged for 24 hours at room temperature to form the sol-gel composition of Third distinct layer (third distinct layer of hydrophobic alkoxysilane)
d) Multi-layer Coating on Substrate
   i. Coating of substrate with sol-gel composition of fist distinct layer: As the substrate to be coated, stainless steel substrates (SS-304 rectangular flat 5 cm×10 cm×1 mm) is used. Prior to coating, the steel substrate was optionally cleaned with 20% nitric acid, to remove the existing corrosion if present and then rinsed with organic solvent (acetone) followed by distilled water and then blown dry with nitrogen. The sol-gel composition of first distinct layer was applied onto the substrate by dip-coating method at a dip speed of 1 mm/s, withdrawal rate of 600 μm/s, retention time of 2 minutes and dried for 2 minutes at a temperature of 70° C. The above process of dip-coating was run to three times and heat treated using a hot air gun to sinter at 300° C. to form the first distinct layer. The thickness of the first distinct layer on substrate was about 400 nm.
   ii. Coating of sol-gel composition of second distinct layer on first distinct layer: The sol-gel composition of second distinct layer was applied onto the first distinct layer coated on substrate by dip-coating method at a dip speed of 1 mm/s, withdrawal rate of 600 μm/s, retention time of 2 minutes and dried for 2 minutes at a temperature of 70° C. The above process of dip-coating was run to three times and dried at 300° C. The thickness of the second distinct layer was about 400 nm.
   iii. Coating of sol-gel composition of third distinct layer on second distinct layer: The sol-gel composition of third distinct layer was applied onto the second distinct layer by immersing the second distinct layer coated substrate into the sol-gel composition of third distinct layer for 60 seconds and heat treated at 100° C. The thickness of the third distinct layer was about 400 nm.

### Example 2: Corrosion Measurement Techniques for Multilayer Coatings on Steel Substrate (Example 1)

Potentiometer CH1760E electrochemical work station (CH Instruments, Inc.), containing three electrodes where steel substrates of example 1 (as working electrode), reference electrode (Calomel) and counter electrode (Platinum) was immersed in 3.5% sodium chloride solution (electrolyte) as per ASTM G3-89 and ASTM G102-89 standards and the following were measured.

1. Potentiodynamic polarization: Potentiodynamic polarization technique was used to evaluate the corrosion rate. A Tafel plot was generated by beginning the scan at applied potential from −1.5 V to +1V. The corrosion current (i_{CORR}) and corrosion potential (E_{CORR}) was obtained. The resulting data is plotted as the applied potential vs. the logarithm of the measured current (FIG. 2). The corrosion rate (CR) was calculated using equation 1.

$$CR ( mpy ) = \frac{0.13 \times {i}_{CORR} \times E . W}{A \times d} \qquad ( Eq \text{.1} )$$

where CR is the corrosion rate in mpy (mils per year), i_{CORR} is the corrosion current in microampere (μA), E.W is equivalent weight of the corroding species in gram (g), A is the surface area of the specimen in square centimetre and d is the density of the specimen in gram per cubic centimetre.
The inhibition efficiency was calculated using equation 2.

$$Inhibition Efficiciency ( \% ) = \frac{( {i}_{CORR} B - {i}_{CORR} C )}{{i}_{CORR} B} \times 100 \qquad ( Eq \text{.2} )$$

where i_{CORR}B is the corrosion current in microampere (μA) of bare steel substrate and i_{CORR}C is the corrosion current in microampere (μA) of coated substrate. The results of E_{CORR}, i_{CORR}, CR & Inhibition efficiency (%) depicted in Table 1 after immersion of coated substrate in 3.5% NaCl for 3 hours.

TABLE 1

| | | | Inhibition |
|---|---|---|---|
| Ecorr (V) | Icorr (A/cm⁻²) | CR (mpy) | efficiency (%) |
| −0.491 | 2.758 × 10⁻⁷ | 2.11 × 10⁻² | 99.99% |

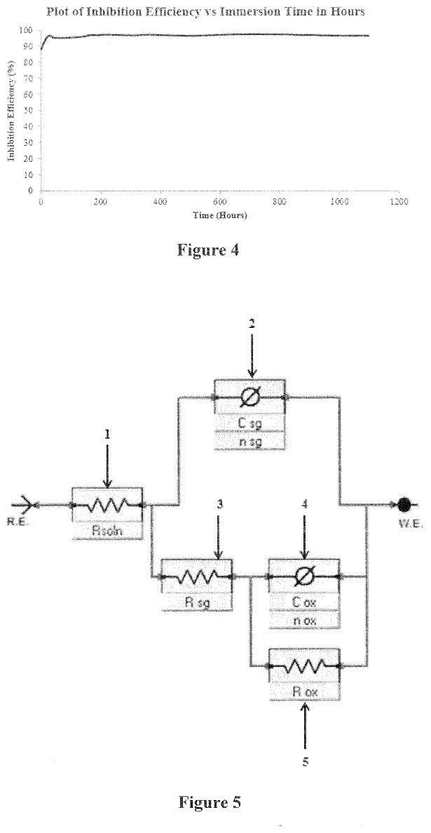

Corrosion rate vs. Time & inhibition efficiency vs. Time: Tafel plot technique was used to evaluate the corrosion rate. A Tafel plot was generated by beginning the scan from −0.2V to +0.2V vs. corrosion potential (E_{CORR}). The corrosion current (i_{CORR}) and corrosion potential (E_{CORR}) was obtained. The corrosion rate (CR) was and inhibition efficiency (%) was calculated with Eq. 1 and Eq. 2 respectively at regular interval (every 24 hours), for a period of 1400 hours. The Corrosion rate vs. Time & inhibition efficiency (%) vs Time was depicted in FIG. 3 and FIG. 4 respectively. The multilayer coating of the present invention (coated steel substrate with three layers) sustained for about 1100 hours (at least 45 days) at corrosion inhibition efficiency (99%).

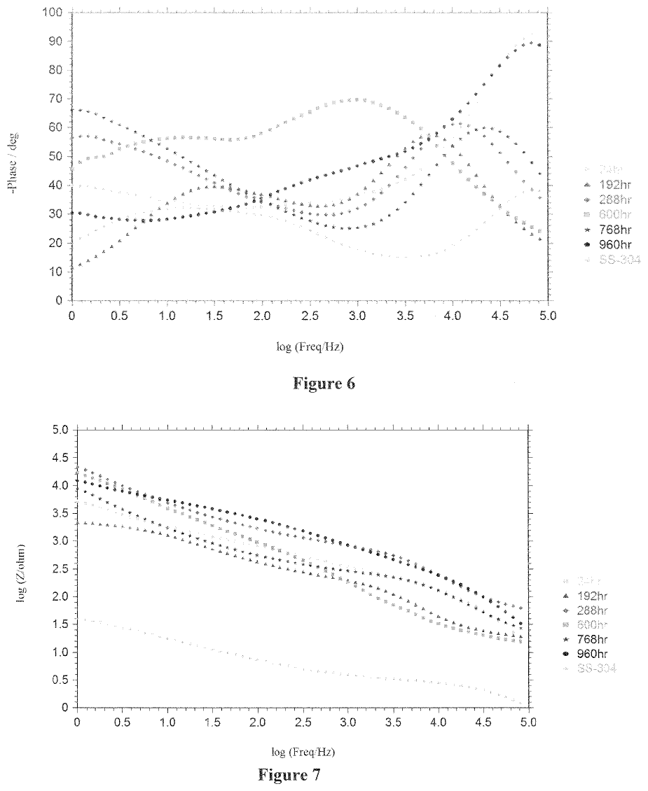

2. Electrochemical impedance spectroscopy (EIS): EIS is scanned with a sinusoidal voltage in an electrochemical cell (potentiometer) to determine interfacial and surface phenomenon on multi-layered coated substrate (Example 1) by immersing multi-layered substrate in 3.5% NaCl solution for 960 hours using the circuit (FIG. 5; circuit is constructed with two capacitors and two resistors based on the two time constants in both the bare steel substrate and the multi-layered substrate as plotted in phase vs. log frequency in FIG. 6) with frequencies ranging from 10⁵ HZ to 1 HZ and the resulting data is plotted as log z (impedance) vs. log frequency (FIG. 7).

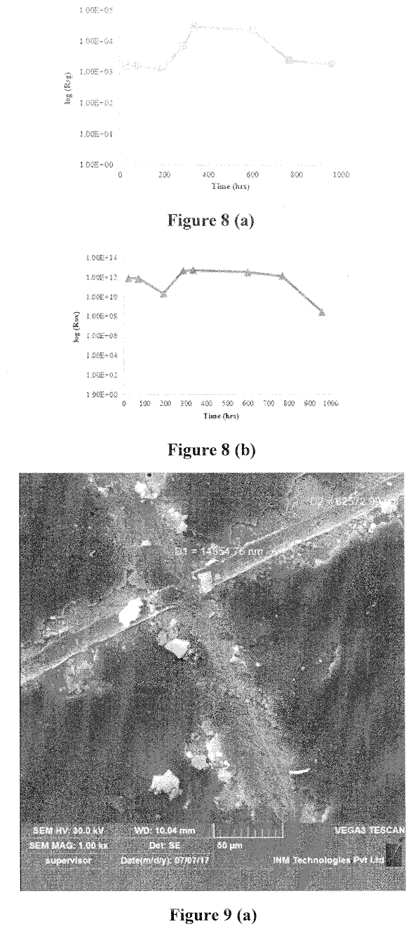

From FIG. 7, it is observed that corrosion resistance remains stable up to 72 hours. There is an increase in Rsg (pore resistance depicted as 3 in FIG. 5) due to uptake of electrolyte by the multi-layered coating, further there is a decrease of Rsg (pore resistance depicted as 3 in FIG. 5) and Rox (oxide resistance depicted as 5 in FIG. 5) as time progress due to the onset cracking of third distinct layer, wherein the corrosion resistance drops to minimum at 192 hours, further at 288 hours, there is a rapid rise of both the Rsg (pore resistance depicted as 3 in FIG. 5) and Rox (oxide resistance depicted as 5 in FIG. 5) due to the diffusion of cerium ions from second distinct layered to cracked regions of third distinct layer (passivation through the precipitation of Ce(OH)₄), further at 336 hours both the Rsg (pore resistance depicted as 3 in FIG. 5) and Rox (oxide resistance depicted as 5 in FIG. 5) reaches maximum and remains stable at this point till 960 hours, indicating the ability of multi-layer coating (example 1) to self-heal and repair damages due to electrolyte attack as depicted in FIG. 8 (a) and FIG. 8(b).

### Example 3: Self-Healing Property

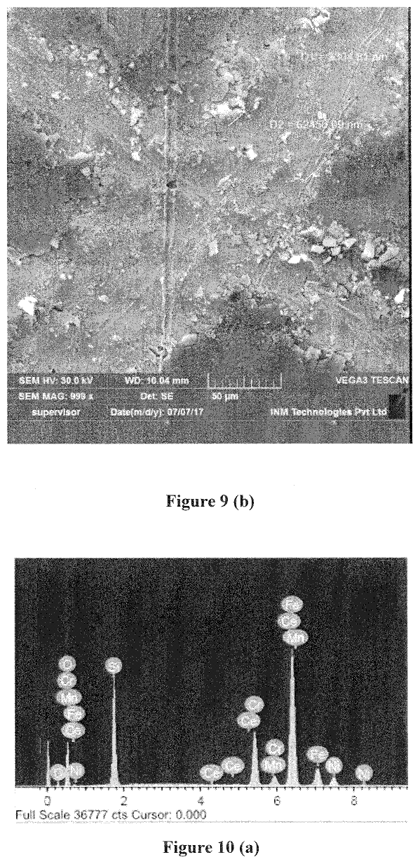

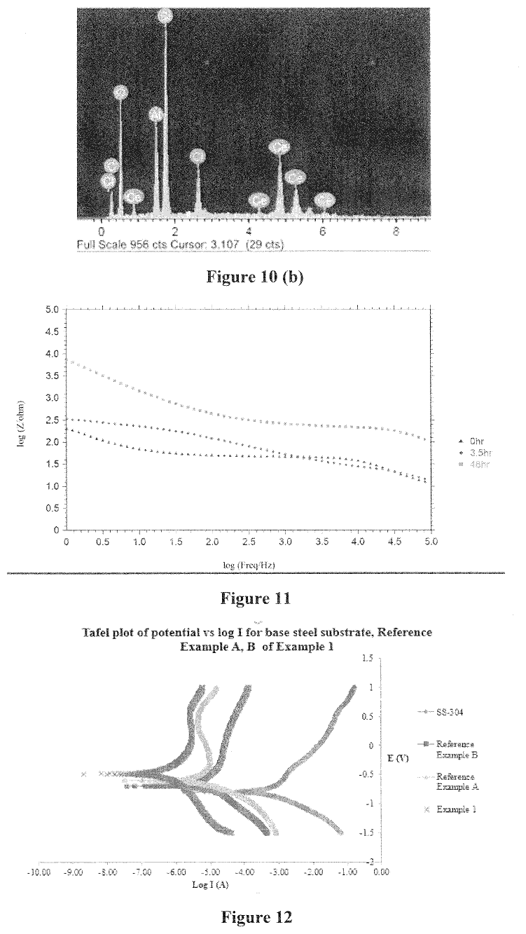

Self-healing test was carried out by applying a scratch on the surface of the multi-layered coated substrate (example 1), which was further dipped in 5% NaCl electrolyte and monitored at 0 hours and 48 hours, using scanning electron microscopy (FIG. 9(a) and FIG. 9(b)) depicting that the scratch healed at 48 hours compared to 0 hours, and further for elemental analysis (FIG. 10 (a) and FIG. 10(b)) at 0 hours and 48 hours, depicting that peaks for cerium started to appear after 48 hours indicating second distinct layers self-healing ability.
Further EIS was carried out at 0, 3.5 hours and 48 hours by dipping the scratched multi-layered coated substrate in 5% NaCl electrolyte with a potentiometer having three electrodes as per example-2 and the log z vs. log frequency was plotted in FIG. 11, depicting that the corrosion impedance increased at 48 hours as compared to 0 hours.

### Reference Example A: Second Distinct Layer Coating on Steel Substrate

Second distinct layer of silica-ceria was prepared and coated on the stainless steel substrate (SS-304) as disclosed in example 1.

### Reference Example B: Third Distinct Layer Coating on Steel Substrate

Third distinct layer of hydrophobic alkoxysilane was prepared and coated on the stainless steel substrate (SS-304) as disclosed in example 1.

### Reference Example C: Double Layer Coating of Second & Third Distinct Layer Coating on Steel Substrate

Second distinct layer of silica-ceria was prepared and coated on the stainless steel substrate (SS-304), followed by Third distinct layer of hydrophobic alkoxysilane coating on the second distinct layer as disclosed in example 1.

### Example 4: Comparison of Corrosion Measurement Techniques for Multilayer Coatings on Steel Substrate (Example 1), Reference Examples a, B & C

The potential vs. the logarithm of the measured current (Tafel plots FIG. 12) was plotted by the procedure as described in example 2 for samples of reference example A, reference example B, bare steel metal substrate, and multi-layered coated example 1 which depicts that the multi-layer coating of example 1 has more corrosion resistance when compared to the other samples. Reference sample A and example 1 have displayed passivation effect under high positive voltages.

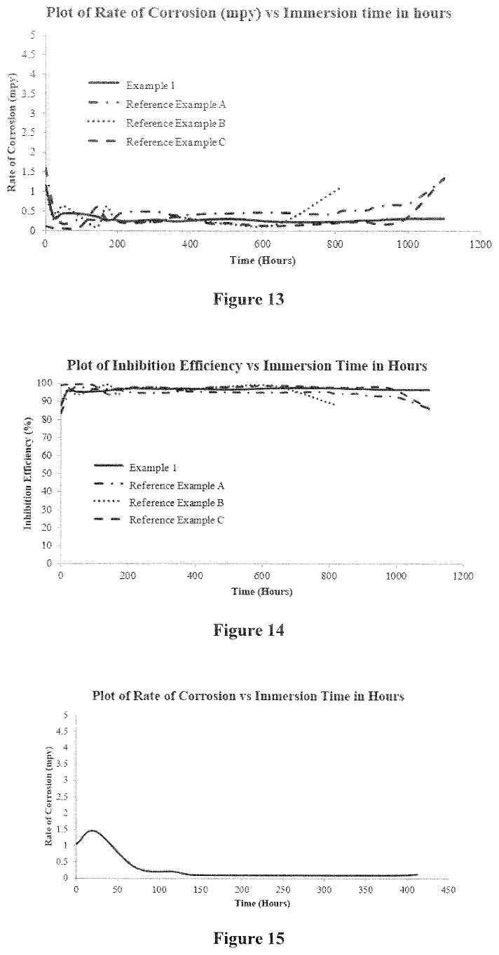

Corrosion rate vs. Time & inhibition efficiency vs Time: Corrosion rate vs. Time & inhibition efficiency vs Time plots (FIG. 13 & FIG. 14) was plotted by the procedure as described in example 2 for samples of reference example A, reference example B, reference example C and multi-layered coating of example 1, which depicts that the multi-layer coating of example 1 has less corrosion rate and more inhibition efficiency, when compared to other samples. Inhibition efficiency of reference examples A, B, C and example 1 are disclosed in Table 2.

TABLE 2

| | Corrosion inhibition |
|---|---|
| Example No | Efficacy at 90% in Hours |
| Reference Example A | 820 |
| Reference Example B | 500 |
| Reference Example C | 960 |
| Example 1 | 1100 |

### Example 5: Multilayer Coatings on Aluminium Substrate

a) Making of sol-gel composition of first distinct layer (first distinct layer of Aluminium oxide): 5 g of aluminium sec-butoxide was mixed with 100 ml 2-methoxyethanol and stirred vigorously at 600 rpm for 4 hours to form the sol-gel composition of first distinct layer (first distinct layer of Aluminium oxide)
b) Making of sol-gel composition of second distinct layer (second distinct layer of silica-ceria): 18.8 g of TEOS (tetraethoxysilane or tetraethyl orthosilicate) was mixed with 200 ml of 2-methoxyethanol to form a yellow sol. Subsequently 4.3 g of cerium(III) nitrate hexahydrate was mixed with 200 ml of 2-methoxyethanol and vigorously stirred at 600 rpm for 4 hours to form an orange sol. Yellow sol and orange sol are mixed together in ratio of 1:1 volume such that the cerium concentration in the final sol was 0.05M to form a hybrid sol, which was further aged for 24 hours at room temperature to form the sol-gel composition of second distinct layer (second distinct layer of silica-ceria).
c) Making of sol-gel composition of third distinct layer (third distinct layer of hydrophobic alkoxysilane): 2.8 g of MTMS (methyltrimethoxysilane) was mixed with 100 ml of water and stirred for 30 minutes to obtain a MTMS transparent sol. Subsequently 0.1 g of sodium dodecyl sulfate was added to the MTMS transparent sol and stirred for 30 minutes. Subsequently 2 ml of 25% of ammonia and 1.8 g of TEOS (tetraethoxysilane or tetraethyl orthosilicate) to the above sol, which was further aged for 24 hours at room temperature to form the sol-gel composition of Third distinct layer (third distinct layer of hydrophobic alkoxysilane)
d) Multi-layer Coating on Substrate
   i. Coating of substrate with sol-gel composition of fist distinct layer: As the substrate to be coated, Aluminium substrate (Al4024-rectangular flat 5 cm×10 cm×1 mm) are used. Prior to coating, the Aluminium substrate was cleaned with organic solvent (isopropanol) rinsed with distilled water and then blown dry with nitrogen. The sol-gel composition of first distinct layer was applied onto the substrate by dip-coating method at a dip speed of 1 mm/s, withdrawal rate of 600 μm/s, retention time of 2 minutes and dried for 2 minutes at a temperature of 70° C. The above process of dip-coating was run to three times and heat treated using a hot air gun to sinter at 300° C. to form the first distinct layer. The thickness of the first distinct layer on substrate was about 400 nm.
   ii. Coating of sol-gel composition of second distinct layer on first distinct layer: The sol-gel composition of second distinct layer was applied onto the first distinct layer coated on substrate by dip-coating method at a dip speed of 1 mm/s, withdrawal rate of 600 μm/s, retention time of 2 minutes and dried for 2 minutes at a temperature of 70° C. The above process of dip-coating was run to three times and dried at 300° C. The thickness of the second distinct layer was about 400 nm.
   iii. Coating of sol-gel composition of third distinct layer on second distinct layer: The sol-gel composition of third distinct layer was applied onto the second distinct layer by immersing the second distinct layer coated substrate into the sol-gel composition of third distinct layer for 60 seconds and heat treated at 100° C. The thickness of the third distinct layer was about 400 nm.

### Example 6: Corrosion Measurement Techniques for Multilayer Coatings on Aluminium Substrate (Example 5)

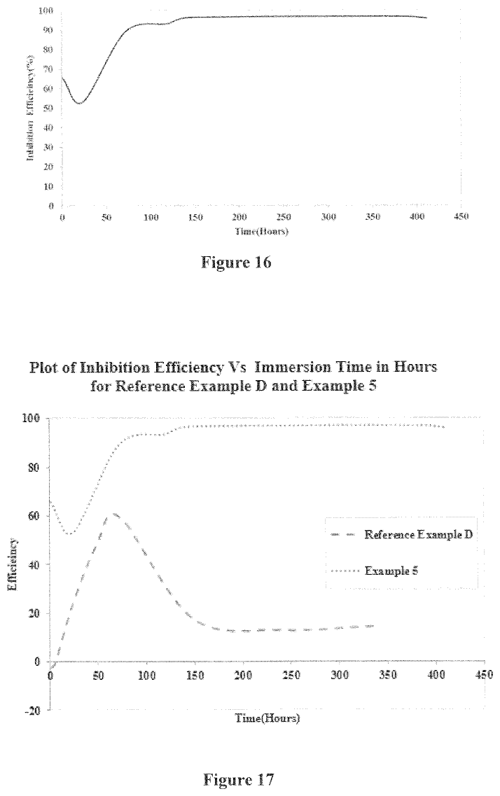

Corrosion rate vs. Time & inhibition efficiency vs Time: Corrosion rate vs. Time & inhibition efficiency vs Time plots (FIG. 15 & FIG. 16) was plotted by the procedure as described in example 2 for multi-layered coating of aluminium substrate of Example-5.

### Reference Example D: Single Layer Coating on Aluminium Substrate

Single layer coatings essentially of ceria and silica, with the optional layers of lanthanum oxide as discussed in US Patent Publication No. 20140255611A1 was coated onto the aluminium substrate by the method as disclosed in Example 4 on Aluminium Substrate.

### Example 7: Comparison of Corrosion Measurement Techniques for Multilayer Coatings on Aluminium Substrate (Example 5) and Reference Examples D

Inhibition efficiency vs Time: Inhibition efficiency vs Time plots (FIG. 17) was plotted by the procedure as described in example 2 for samples of reference example D and multi-layered coated aluminium sample of example 5, which depicts that the multi-layer coating of example 5 has more inhibition efficiency, when compared to reference example D. Inhibition efficiency of reference examples A, B, C and example 1 are disclosed in Table 3.

TABLE 3

| | Corrosion inhibition Efficacy at |
|---|---|
| Example No | 90% in hours |
| Comparative Example D | 100 |
| Example 4 | More than 425 |

1. A multilayer coating on a metal substrate comprising
(a) A first distinct layer of a first sol-gel composition disposed over the substrate, wherein the first distinct layer comprises an inorganic oxide,
(b) A second distinct layer of a second sol-gel composition disposed over the first distinct layer, wherein the second distinct layer comprises silica and ceria, and
(c) A third distinct layer of a third sol-gel composition disposed over the third distinct layer, wherein the third distinct layer comprises at least one alkoxysilane.

2. The multilayer coating of claim 1, wherein inorganic oxide is selected from group consisting of ferric oxide, ferrous oxide, aluminium oxide, magnesium oxide, cupric oxide, copper oxide, titanium dioxide, magnesium oxide and nickel oxide or combinations thereof.

3. The multilayer coating of claim 1, wherein the second distinct layer comprises silica and ceria prepared from precursors of about 80% w/w tetraethoxysilane (TEOS) and of about 20% w/w cerium nitrate hexahydrate.

4. The multilayer coating of claim 1, wherein third distinct layer comprises alkoxysilanes consisting of about 60% w/w methyltrimethoxysilane (MTMS) and of about 38% w/w tetraethoxysilane (TEOS) and optionally of about 2% w/w of surfactant.

5. The multilayer coating of claim 1, wherein the thickness of each distinct layer is about 400 nm.

6. A multilayer coating on a steel substrate comprising
(a) A first distinct layer of a first sol-gel composition disposed over the substrate, wherein the first distinct layer comprises ferric oxide,
(b) A second distinct layer of a second sol-gel composition disposed over the first distinct layer, wherein the second distinct layer comprises silica and ceria, and
(c) A third distinct layer of a third sol-gel composition disposed over the third distinct layer, wherein the third distinct layer comprises at least one alkoxysilane.

7. The multilayer coating of claim 6, wherein the second distinct layer comprises silica and ceria prepared from precursors of about 80% w/w tetraethoxysilane (TEOS) and of about 20% w/w cerium nitrate hexahydrate.

8. The multilayer coating of claim 6, wherein third distinct layer comprises alkoxysilanes consisting of about 60% w/w methyltrimethoxysilane (MTMS) and of about 38% w/w tetraethoxysilane (TEOS) and optionally of about 2% w/w of surfactant.

9. The multilayer coating of claim 6, wherein the thickness of each distinct layer is about 400 nm.

10. A multilayer coating on a steel substrate comprising
(a) A first distinct layer of a first sol-gel composition disposed over the substrate, wherein the first distinct layer comprises ferric oxide,
(b) A second distinct layer of a second sol-gel composition disposed over the first distinct layer, wherein the second distinct layer comprises silica and ceria prepared from precursors of about 80% w/w tetraethoxysilane (TEOS) and of about 20% w/w cerium nitrate hexahydrate, and
(c) A third distinct layer of a third sol-gel composition disposed over the third distinct layer, wherein the third distinct layer comprises alkoxysilanes consisting of about 60% w/w methyltrimethoxysilane (MTMS) and of about 38% w/w tetraethoxysilane (TEOS) and optionally of about 2% w/w of surfactant.
